(19) United States
(12) Patent Application Publication
(10) Pub. No.: US 2017/0012534 A1
(43) Pub. Date: Jan. 12, 2017

(54) Buck-Boost Power Amplifier with Independently Controlled Power Stages and Compensated Nonlinear Pulse Width Modulator

(71) Applicant: Agency for Science, Technology and Research, SIngapore (SG)

(72) Inventors: Jun YU, Singapore (SG); Muthukumaraswamy Annamalai ARASU, Singapore (SG); Minkyu JE, Singapore (SG)

(21) Appl. No.: 15/120,598

(22) PCT Filed: Feb. 25, 2015
(86) PCT No.: PCT/SG2015/050027

§ 371 Date: Aug. 22, 2016

(30) Foreign Application Priority Data
Feb. 25, 2014 (SG) 10201400201T

(51) Int. Cl. H02M 3/158

(52) U.S. Cl. CPC H02M 3/1582

(57) ABSTRACT

A buck-boost power amplifier receiving a supply voltage and providing an output having a voltage swing higher than the supply voltage is provided. The buck-boost power amplifier comprises a buck power stage, a boost power stage, an inductor, and a non-linear pulse width modulator. The buck power stage and the boost power stage are independently controlled by the non-linear pulse width modulator. The non-linear pulse width modulator switches the buck-boost power amplifier between a buck mode wherein the output provides a voltage lower than the supply voltage and a boost mode wherein the output provides a voltage higher than the supply voltage.

### PRIORITY CLAIM

The present application claims priority to Singapore patent application no. 10201400201T, filed on 25 Feb. 2014.

### TECHNICAL FIELD

The present invention relates to power amplifiers. In particular, it relates to buck-boost power amplifiers.

### BACKGROUND ART

Power amplifier is commonly used in electronic circuits to interface with external devices, such as speakers, motors and various transducers, which are treated as loads of the power amplifier.

To achieve long battery life in portable devices, it is critical that the power amplifiers used in such systems have high efficiency. Therefore, switching-mode power amplifiers become desired in battery powered systems. Class-D power amplifier is one of the most widely used switching-mode power amplifiers. However, output voltage swing of a Class-D amplifier is limited by its supply voltage.

For certain applications, the power amplifier needs to generate an output signal with a voltage swing higher than the supply voltage in order to deliver large power to the load. For instance, to drive a piezoelectric transducer in a downhole acoustic telemetry system, the required output voltage swing may be as high as 80 V, whilst the battery supply voltage is only 36 V.

A typical solution in such applications is to use a boost converter 101 to generate a higher supply voltage from the battery, which is then followed by a Class-D power amplifier 103, as shown in FIG. 1. But this approach has some limitations. First, the transient current Iₜᵣₐₙₛ of the Class-D amplifier 103 is fast, thus requiring the boost converter 101 to have a fast load transient response. Accordingly the boost converter 101 needs to be designed with a high cutoff frequency, which is quite hard to achieve due to the existence of the right half-plane zero. Alternatively, as illustrated in FIG. 1, a large decoupling capacitor C_{dp} is required at the output of the boost converter to supply the fast transient current.

Further, from energy transfer point of view, the energy of the power amplifier is boosted to a high voltage level by the boost converter 101 and stored in the capacitor, C_{dp}, and then is scaled down by the Class-D amplifier 103 to produce an output signal. As the energy is not directly transferred from input to output, this energy transfer path is not optimized, so that the efficiency of the whole system is limited and the component stress, i.e., the peak current flowing through inductors and power transistors, is severe. One may consider that the low efficiency in the typical solution illustrated in FIG. 1 can be improved by employing an adaptive boost converter, whose output voltage changes step by step based on the desired output voltage level of the Class-D amplifier. However, this approach requires a complex digital controller design for the boost converter 101. Additionally, the stability of this typical approach is difficult to achieve, as the frequency response of the boost converter 101 is dependent on its output voltage, which is the voltage across the decoupling capacitor C_{dp}.

Another limitation of the typical solution using Class-D amplifier with boost converter is that two inductors, L₁ and L₂, are required, one for the boost converter 101 and the other for the Class-D amplifier 103. The two-inductor design causes the off-chip components of the power amplifier to take large area and raises the cost of the power amplifier system. Further, when integrating the power amplifier system on chip, power MOSFETs M₁-M₄ used in the boost converter 101 and the Class-D amplifier 103 require a breakdown voltage higher than the maximum output voltage Vₒᵤₜ, which occupies a large chip area.

To avoid the drawbacks of the typical solution illustrate in FIG. 1 using Class-D power amplifier with boost converter, another approach is known for using buck/boost power stages in the switching-mode power amplifier. The buck/boost power stages are as that used in DC-DC converter applications, which has the capability to generate an output voltage higher than the supply voltage. Two reported buck/boost power amplifiers utilizing buck/boost power stage designs are shown in FIGS. 2 and 3. In the buck/boost power stage designs as shown in FIGS. 2 and 3, transfer functions from duty cycle to output voltage are no longer linear. Thus, a nonlinear pulse width modulator is needed in the power amplifier. For example, the nonlinear pulse width modulator may be built using analog circuit by employing an exponential carrier generator.

However, in the reported two buck/boost power amplifiers, power transistors or switches are controlled complementarily, which cause greater component stress, as there is no direct energy transfer path from input to output. In addition, in the buck/boost power stages as shown in the FIGS. 2 and 3, all the power transistors Q₁, Q₂ or switches S₁ to S₅ need to be able to sustain the maximum voltage of the output signal, hence power transistors with a high breakdown voltage are required. However, power transistors with high breakdown voltage occupy large silicon area due to their large physical size.

Thus, what is needed is a switching-mode power amplifier, especially a buck/boost power amplifier, that has independent control of the power transistors used in the power stages, to reduce the component stress and the size of the integrated chip. Furthermore, other desirable features and characteristics will become apparent from the subsequent detailed description and the appended claims, taken in conjunction with the accompanying drawings and this background of the disclosure.

### SUMMARY OF INVENTION

According to the present application, a buck-boost power amplifier receiving a supply voltage and providing an output having a voltage swing higher than the supply voltage is provided. The buck-boost power amplifier comprises a buck power stage, a boost power stage, an inductor, and a non-linear pulse width modulator. The buck power stage and the boost power stage are independently controlled by the non-linear pulse width modulator. The non-linear pulse width modulator switches the buck-boost power amplifier between a buck mode wherein the output provides a voltage lower than the supply voltage and a boost mode wherein the output provides a voltage higher than the supply voltage.

### BRIEF DESCRIPTION OF DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with a present embodiment.

FIG. 1 depicts a circuit diagram of a typical Class-D amplifier with a boost convertor. The boost converter is utilised to generate a supply voltage higher than the battery voltage, and to power the Class-D amplifier.

FIG. 2 depicts a circuit diagram of a reported switching-mode power amplifier which utilises buck/boost power stages.

FIG. 3 depicts a circuit diagram of another reported switching-mode power amplifier which utilises buck/boost power stages.

FIG. 4 depicts a circuit diagram of a buck-boost power amplifier in accordance with the present embodiment, which comprises a buck cascaded buck-boost (BuCBB) power stage and a non-linear pulse width modulator.

FIG. 5 depicts a waveform diagram of signal waveforms of input signal V_{IN}, amplified output signal V_{OUT}, a first signal pwm_bu, a second signal pwm_bo, and two switching nodes SW1 and SW2 of the BuCBB power stage as shown in FIG. 4, in accordance with the present embodiment.

FIG. 6 depicts a bode diagram showing a transfer function variation of the buck-boost power amplifier when operating in the boost mode, whereas a transfer function of the buck-boost power amplifier operating in the buck mode is also plotted as a reference.

FIG. 7 depicts a block diagram of a digital approach of the non-linear pulse modulator in buck-boost power amplifier in accordance with the present embodiment.

FIG. 8 depicts a waveform diagram of a phase compensation mechanism in accordance with the present embodiment.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DESCRIPTION OF EMBODIMENTS

The following detailed description is merely exemplary in nature and is not intended to limit the invention or the application and uses of the invention. Furthermore, there is no intention to be bound by any theory presented in the preceding background of the invention or the following detailed description. Herein, a buck-boost power amplifier is presented in accordance with present embodiments having lower component stress, higher power efficiency, and advanced linearity performance.

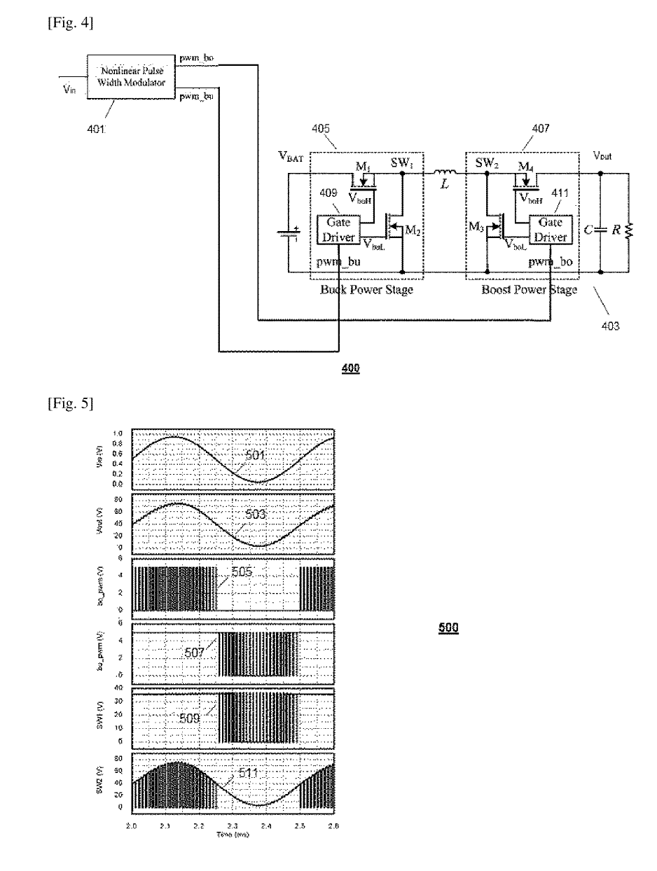

Referring to FIG. 4, a block diagram 400 of a buck-boost power amplifier in accordance with a present embodiment is depicted. The buck-boost power amplifier 400 comprises a non-linear pulse modulator 401 and a buck cascaded buck-boost (BuCBB) power stage 403. The BuCBB power stage 403 comprises a buck power stage 405, a boost power stage 407, an inductor L, and optionally, a capacitor C. In the present embodiment shown in FIG. 4, the buck power stage 405, the boost power stage 407 and the inductor L are wired in series and connected to a supply voltage. In the present embodiment, the supply voltage is a battery of 36 V. In the present embodiment, a load resistor R is connected at the output of the BuCBB power stage 403.

An input signal Vᵢₙ is provided to the non-linear pulse width modulator 401 to produce two signals. Both signals are pulse width modulated by the non-linear pulse width modulator 401. One of the two signals is denoted as a first signal, named pwm_bu, and the other of the two signals is denoted as a second signal, named pwm_bo. The first signal pwm_bu and the second signal pwm_bo are provided into the BuCBB power stage 403. Specifically, the first signal pwm_bu is provided into the buck power stage 405, and the second signal pwm_bo is provided into the boost power stage 407. By virtue of the individually provided signals, the buck power stage 405 and the boost power stage 407 are independently controlled.

In the present embodiment, the buck power stage 405 and the boost power stage 407 are formed by power transistors. In particular, two power transistors M₁ and M₂ form the buck power stage 405; while another two power transistors M₃ and M₄ form the boost power stage 407. In the present embodiments, two gate drivers 409 and 411 are provided in the two power stages. The provision of the first signal pwm_bu is connected to the gate driver 409, which processes the first signal pwm_bu then produces a pair of complementary signals: V_{buL} and V_{buH}. V_{buL} is then provided to the second power transistor M₂, whereas V_{buH} is provided to the first power transistor M₁. Similarly, the provision of the second signal pwm_bo is connected to the other gate driver 411, which processes the second signal pwm_bo then produces a pair of complementary signals: V_{boL} and V_{boH}. V_{boL} is then provided to the third power transistor M₃, whereas V_{boH} is provided to the fourth power transistor M₄.

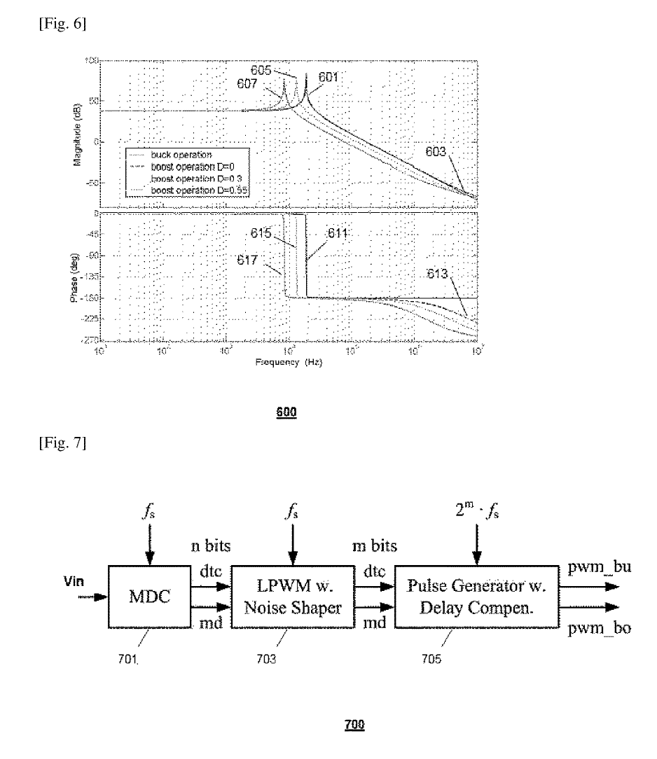

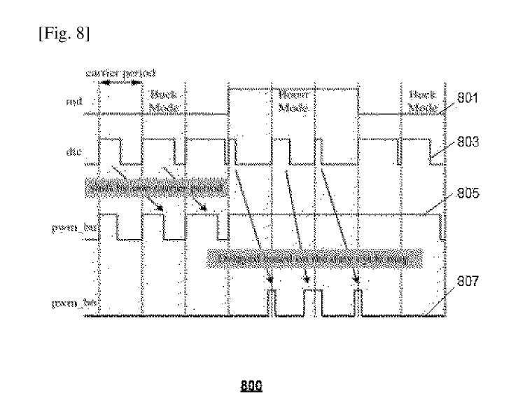

As described above, as improved from the reported buck/boost amplifiers as shown in FIGS. 2 and 3, in the BuCBB power stage 403 ultilised in the present embodiment, the buck power stage 405 and the boost power stage 407 as shown in FIG. 4 are independently controlled by two signals, i.e., pwm_bu and pwm_bo respectively. These two control signals, pwm_bu and pwm_bo, are pulse signals generated by the non-linear pulse width modulator. The generation of the two control signals, pwm_bu and pwm_bo, will be described in the following description with respect to the non-linear pulse width modulator shown in FIGS. 7 and 8.

In response to the two control signals, i.e. the first signal pwm_bu and the second signal pwm_bo, the buck-boost power amplifier 400 switches between two operating modes: buck mode and boost mode. When working in the buck mode, the fourth power transistor M₄ is on and the third transistor M₃ is off, thus the boost power stage 407 behaves as a short circuit that connects the inductor L directly to the output, and a switching node SW2, which connects the inductor L, the fourth power transistor M₄ and the third transistor M₃, shares the same voltage as the output Vₒᵤₜ. In the buck mode, the first power transistor M₁ and the second power transistor M₂ behave as switches in response to the pair of complementary signals, V_{buL} and V_{buH}. To contrast, when working in the boost mode, the first power transistor M₁ is on and the second power transistor M₂ is off, thus the buck power stage 405 behaves as a short circuit that connects the inductor L directly to the supply. Accordingly, another switching node SW1, which connects the inductor L, the first power transistor M₁ and the second power transistor M₂, shares the same voltage as the supply voltage V_{BAT}. In the boost mode, the third power transistor M₃ and the fourth transistor M₄ work as switches.

Referring to FIG. 5, a diagram of signal waveforms of input signal Vᵢₙ, amplified output signal Vₒᵤₜ, the first control signal pwm_bu, and the second control signal pwm_bo, the switching nodes SW1 and SW2 of the BuCBB power amplifier are shown. As shown in FIG. 5, waveform 505 shows that the first control signal pwm_bu contains a pulsed signal generated by the non-linear pulse modulator 401 to be provided to the buck power stage 405, and waveform 507 shows that the second control signal pwm_bo contains a pulsed signal generated by the non-linear pulse modulator 401 to be provided to the boost power stage 407.

In FIG. 5, waveform 501 shows the input signal Vᵢₙ which signal range is from 0 to 1. Waveform 503 shows that the amplified output signal Vₒᵤₜ has a voltage swing of 72 V. The second control signal pwm_bo is generated as waveform 505 shows and is provided to the boost power stage, whereas waveform 507 shows the first control signal pwm_bu and is provided to the buck power stage. Waveform 509 shows that the voltage level at the switching node SW1 has a voltage swing only from 0 V to the battery supply voltage V_{BAT}, which in the present embodiment is 36 V. On the other hand, the voltage level at the switching node SW2 has the same envelop as the output Vₒᵤₜ, as shown in waveform 511.

The lower voltage swing at the switching node SW1 allows the first power transistor M₁ and the second power transistor M₂ to have mitigated component stresses, and that they can be implemented using power MOSFETs having lower breakdown voltage. It will be appreciated by the skilled person in the art that in some commercial fabrication process, other drain-extended power transistors are also available for use in the present embodiment to provide different maximum drain to source voltages V_{DS}. Also, it will be appreciated that the selection of shorter drain-extended device significantly reduces the whole area of the power transistor under the same on-resistance requirement.

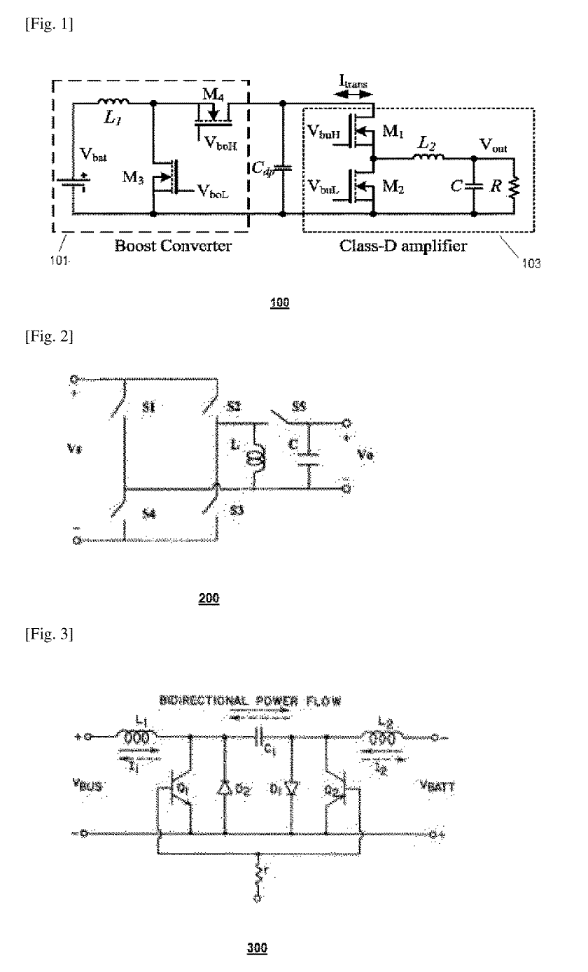

Additionally, the buck power stage 405 and the boost power stage 407 share the same inductor L, and do not need a large decoupling capacitor in-between them. Hence, the buck-boost power amplifier 400 needs much less off-chip components as compared to the typical Class-D amplifier with boost converter design 100 as shown in FIG. 1, thus can be implemented in a smaller print circuit board (PCB) area and at cheaper price.

Different from known buck-boost DC-DC converters, the output voltage of the buck-boost power amplifier Vₒᵤₜ varies with respect to the input signal V_{in,} and needs to frequently switch between the buck mode and the boost mode operations. Therefore, when adopting the independently controlled BuCBB power stage 403 for power amplification applications, the distortions due to circuit nonlinearity and operating mode switches need to be investigated and compensated.

The BuCBB power stage 403 is firstly investigated in direct current (DC) analysis. In DC environment, the input signal Vᵢₙ is constant, so that the duty cycles of the two control signals pwm_bu and pwm_bo keep unchanged. The relationship between the duty cycle, supply voltage and output signal with respect to the two operating modes are expressed as:

Buck Mode: Vₒᵤₜ=D_{bu}×V_{BAT} [Math.1]

Boost Mode: Vₒᵤₜ=V_{BAT}/(1−D_{bo}) [Math.2]

where D_{bu} and D_{bo} represent the duty cycles of the two control signals, pwm_bu and pwm_bo, respectively. Although the transfer functions derived in Eqns. (1) and (2) are based on constant input signal in the present embodiment, they are approximately held for low frequency input signal with an assumption that switching frequency fₛ of the BuCBB power stage 403 is much higher than the input signal frequency. Hence, the input signal keeps almost constant in each carrier period T_{s,} where Tₛ=1/fₛ.

As indicated by Eqns. (1) and (2), the output voltage Vₒᵤₜ is lower than the supply voltage V_{BAT} when working in the buck mode, but higher than the supply voltage V_{BAT} when working in the boost mode. The selection of the operating mode is controlled by the input signal. The control is to compare the voltage of the input signal with a designed threshold voltage, as follows:

If Vᵢₙ<Vₜₕ, D_{bu}=f₁(Vᵢₙ), D_{bo}=0 and md=0; and

If Vᵢₙ>Vₜₕ, D_{bu}=1, D_{bo}=f₂(Vᵢₙ) and md=1,

where Vₜₕ=V_{BAT}/V_{OH} [Math.3]

When the BuCBB power stage 403 works in the boost mode, based on Eqn. (2), the transfer function from duty cycle to the output voltage is nonlinear. To achieve a linear transfer function from Vᵢₙ to Vₒᵤₜ, a nonlinear transfer function from input voltage Vᵢₙ to the duty cycle of the boost mode D_{bo} is used to compensate the overall linearity. In the present embodiment, the nonlinear transfer function from Vᵢₙ to D_{bo} is expressed as:

D_{bo}=1−(V_{BAT}/V_{OH})/Vᵢₙ [Math.4]

Substituting D_{bo} of Eqn. (4) into Eqn. (2), a linear transfer function from Vᵢₙ to Vₒᵤₜ is achieved and calculated as:

Vₒᵤₜ=V_{OH}×Vᵢₙ [Math.5]

Respectively, when working in the buck mode, the transfer function from the input signal Vᵢₙ to duty cycle D_{bu} is derived as:

D_{bu}=(V_{OH}/V_{BAT})×Vᵢₙ [Math.6]

With the consideration of the high-frequency double poles generated by the inductor L and capacitor C, FIG. 6 illustrates a bode diagram 600 showing the transfer function from input Vᵢₙ to output Vₒᵤₜ of the buck-boost amplifier 400 with respect to the duty cycle when the buck-boost amplifier 400 operates in the boost mode. FIG. 6 contains two aspects of the same transfer function variation, i.e. with regard to the phase of the input signal and with regard to the magnitude of the input signal. The transfer function for the buck mode operation with regard to the phase of the input signal and the magnitude of the input signal are also plotted as waveforms 611 and 601 respectively, as a reference. It is shown in FIG. 6 that the transfer function for the boost mode operation when D_{bo}=0, represented by waveform 603 and waveform 613, almost overlaps with the transfer function for the buck mode operation, represented by waveform 601 and waveform 611. In the present embodiment shown in FIG. 6, the desired input signal frequency range is from 400 Hz to 2 k Hz, and the cut-off frequency of the LC circuit is designed at 20 k Hz. As shown in FIG. 6, waveform 605 and waveform 615 show the transfer function for the boost mode operation when D_{bo}=0.3, whereas waveform 607 and waveform 617 show the transfer function for the boost mode operation when D_{bo}=0.55. As shown by the variation from waveforms 603 to 605 to 607 (or from waveforms 613 to 615 to 617), when working in the boost mode, a double-pole shifts to low frequency when the duty cycle D_{bo} increases, which causes increased phase delay at the input signal frequency.

In the present embodiment, the location of the double-pole is expressed as:

$${ω}_{0} = \frac{1}{\sqrt{LC}} \cdot \sqrt{\frac{{r}_{L} + {( 1 - {D}_{bo} )}^{2} \cdot R}{R}} \approx \frac{1}{\sqrt{LC}} \cdot \frac{{V}_{BAT}}{{V}_{out}} \qquad [ Math . 7 ]$$

where r_{L} is the equivalent series resistance of the inductor L, and R is the load resistance. As shown in Eqn. (7), the frequency of the double-pole decreases when the duty cycle D_{bo} or the output voltage Vₒᵤₜ increases.

Based on the above description, the skilled person in the art would understand that the nonlinear pulse width modulator 401 selects the operating mode of the power stage based on the input signal amplitude Vᵢₙ and is designed to compensate the nonlinearity of the BuCBB power stage 403. The analog approach of the nonlinear pulse width modulator as used in the art appears inappropriate to the present embodiment due to the requirement of operating mode switches. Consequently, a digital approach of the nonlinear pulse width modulator 401 is provided in the embodiment of the present application to control the BuCBB power stage 403 and is described as follows.

FIG. 7 shows a block diagram of the digital approach 700 of the nonlinear pulse width modulator. The digital nonlinear pulse width modulator 700 comprises three functional blocks, i.e. Mode and Duty cycle Controller (MDC) 701, Linear Pulse Width Modulation (LPWM) with noise shaper 703, and Pulse generator with delay compensation 705. As shown in FIG. 7, a sampling clock signal having a frequency fₛ (same as the switching frequency of the BuCBB power stage 403) is provided to the MDC 701 and LPWM with noise shaper block 703. The MDC block 701 processes the input signal Vᵢₙ in view of the sampling clock signal having the frequency fₛ, and derives a duty cycle signal, named as dtc and an operating mode signal (or interchangeably, a mode signal), named as md respectively, in accordance with Eqns. (3), (4) and (6). The duty cycle signal dtc and the mode signal md derived from the MDC 701, are provided to the LPWM with noise shaper block 703. The LPWM and noise shaper block 703 detects operating mode changes and triggers different operating logics for the buck mode and the boost mode. In more detail, the LPWM and noise shaper block 703 is used to generate interpolated sampled data based on two adjacent dtc input data and reduce the data length from n bits to m bits. However, when the operating mode changes, the m-bit output for dtc is simply a truncated input, i.e., the least significant (n−m) bits are removed, and all internal registers are reset to 0.

In order to mitigate the frequency response variation with respect to the magnitude of the input signal for the boost mode operation, a phase compensation mechanism is provided to the Pulse generator with delay compensation 705 of the digital nonlinear pulse width modulator 700. Since the pulse generator of the Pulse generator with delay compensation 705 operates at the highest clock frequency, i.e. 2^{m}*fₛ, in the present embodiment, a finest time delay can be inserted in the digital domain. The delay is added based on the mode signal md and the duty cycle signal dtc that are provided to the Pulse generator with delay compensation 705 to generate, modulate, and compensate the first signal pwm_bu and the second signal pwm_bo.

FIG. 8 shows a waveform diagram of a phase compensation mechanism in the Pulse generator with delay compensation 705, in accordance with the present embodiment. As illustrated in FIG. 8, waveform 801 represents the mode signal md that switches between the buck mode and the boost mode. Waveform 803 represents the duty cycle signal dtc that varies in every carrier period of the buck mode and the boost mode. The duty cycle signal is a digital signal generated from the LPWM with noise shaper 703 in the embodiment shown in FIG. 7, which is represented as a pulse width modulated signal in FIG. 8 to facilitate the explanation of the phase compensation mechanism. The pulse width of the waveform 803 represnts the magnitude of the duty cycle signal dtc. Waveform 805 represents the first signal pwm_bu that controls the buck power stage 405. Waveform 807 represents the second signal pwm_bo that controls the boost power stage 407. As shown in FIG. 8, when operating in the buck mode, the first signal pwm_bu 805 follows the duty cycle signal dtc, but is simply delayed by one carrier period in waveform 805. Oppositely, when working in the boost mode, the second signal pwm_bo 807 follows the duty cycle signal dtc, but is delayed based on the magnitude of the duty cycle signal. The larger the duty cycle signal (the wider the pulse of the waveform 803), the shorter a delay is to be inserted to the second signal pwm_bo to compensate the delay that will be introduced in the power stage, e.g. the BuCBB power stage 403 of the buck-boost power amplifier 400.

For the simplicity of explanation, the expressions derived in Eqns. (1)-(6) are simplified without considering the parasitic components, such as the inductor equivalent series resistance, capacitor equivalent series resistance and the on-resistance of the power transistor. With the consideration of these parasitic components, slightly different transfer function equations may be derived. However, it will be appreciated by the skilled person in the art that the general concept of the above described circuit structure, the nonlinear pulse width modulator and the delay compensation mechanism is still valid and applicable.

Thus it can be seen that a buck-boost power amplifier with independently controlled buck cascaded buck-boost (BuCBB) power stage and compensated nonlinear pulse width modulator in accordance with the present embodiments has the advantages of lower component stress, higher power efficiency, and advanced linearity performance. While exemplary embodiments have been presented in the foregoing detailed description, it will be appreciated that a vast number of variations exist.

It will further be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment of the invention, it being understood that various changes may be made in the function and arrangement of elements and method of operation described in an exemplary embodiment without departing from the scope of the invention as set forth in the appended claims.

What is claimed is:

1. A buck-boost power amplifier receiving a supply voltage and providing an output having a voltage swing higher than the supply voltage, the buck-boost power amplifier comprising:
a buck power stage;
a boost power stage;
an inductor; and
a non-linear pulse width modulator, wherein the non-linear pulse width modulator comprises a mode and duty cycle controller (MDC), a linear pulse width modulator (LPWM) and noise shaper, and a pulse generator with delay compensation, wherein the MDC is configured to process an input signal and generate a duty cycle signal and a mode signal, and wherein the mode signal and the duty cycle signal are provided into the LPWM and noise shaper and the pulse generator with delay compensation,
wherein the buck power stage and the boost power stage are independently controlled by the non-linear pulse width modulator, and
wherein the non-linear pulse width modulator switches the buck-boost power amplifier between a buck mode wherein the output provides a voltage lower than the supply voltage and a boost mode wherein the output provides a voltage higher than the supply voltage.

2. The buck-boost power amplifier in accordance with claim 1, wherein the non-linear pulse width modulator produces a first signal to switch the buck-boost power amplifier to the buck mode, and wherein the boost power stage behaves as a short circuit that connects the inductor directly to the output.

3. The buck-boost power amplifier in accordance with claim 2, wherein the non-linear pulse width modulator produces a second signal to switch the buck-boost power amplifier to the boost mode, wherein the buck power stage behaves as a short circuit that connects the inductor directly to the supply.

4. The buck-boost power amplifier in accordance with claim 3, wherein the buck power stage comprises a first power transistor and a second power transistor; and wherein the boost power stage comprises a third power transistor and a fourth power transistor,
wherein the first power transistor is switched on and the second power transistor is switched off by the first signal, and
wherein the third power transistor is switched off and the fourth power transistor is switched on by the second signal.

5. The buck-boost power amplifier in accordance with claim 1, wherein the non-linear pulse width modulator is configured to detect operating mode changes and trigger different operating logics for the buck mode and the boost mode, so as to produce the first signal and the second signal that are pulse width modulated, to switch the buck-boost power amplifier between the buck mode and the boost mode.

6. The buck-boost power amplifier in accordance with claim 5, wherein the non-linear pulse width modulator switches the buck-boost power amplifier between the buck mode and the boost mode in response to a voltage amplitude of the input signal.

7. The buck-boost power amplifier in accordance with claim 5, wherein the non-linear pulse width modulator is configured to linearise a transfer function from the input signal to the output.

8. The buck-boost power amplifier in accordance with claim 7, wherein the linearising is to provide to the MDC a non-linear transfer function from the input signal to a duty cycle of the boost mode.

9. The buck-boost power amplifier in accordance with claim 5, wherein the non-linear pulse width modulator is configured to insert a delay into the pulse generator with delay compensation in response to the mode signal and the duty cycle signal, such that the first signal and the second signal are phase compensated.

10. The buck-boost power amplifier in accordance with claim 1, further comprising a capacitor, wherein the buck power stage, the boost power stage, the inductor and the capacitor form a buck cascaded buck-boost (BuCBB) power stage.
